(19) United States
(12) Patent Application Publication
(10) Pub. No.: US 2019/0127135 A1
(43) Pub. Date: May 2, 2019

(54) LIQUID CONTAINER

(71) Applicant: SEIKO EPSON CORPORATION, Tokyo (JP)

(72) Inventors: Masahiro KARASAWA, Matsumoto-shi (JP); Yuji Aoki, Hara-mura (JP)

(73) Assignee: SEIKO EPSON CORPORATION, Tokyo (JP)

(21) Appl. No.: 16/178,045

(22) Filed: Nov. 1, 2018

(30) Foreign Application Priority Data
Nov. 2, 2017 (JP) 2017-212648

(51) Int. Cl. B65D 77/06; B65D 65/40; B32B 7/12; B32B 15/082; B32B 15/20; B32B 27/30

(52) U.S. Cl. CPC B65D 77/062; B65D 65/40; B32B 7/12; B32B 15/082; B32B 2439/62; B32B 27/306; B32B 2307/7242; B32B 2307/7265; B32B 15/20

(57) ABSTRACT

The present invention provides a technique for a multi-layered container that includes an adhesive layer for bonding adjacent layers, with which it is possible to reduce the possibility of a problem such as a reduction in the function (bonding function) of the adhesive layer occurring. A liquid container for supplying a liquid to a liquid consumption apparatus includes a liquid containing portion, a connection portion that allows the liquid contained in the liquid containing portion to flow into the liquid consumption apparatus, and a housing box that houses the liquid containing portion. The liquid containing portion forms a layer structure in which a plurality of layers are disposed from the inside toward the outside. The layer structure includes an adhesive layer, a gas barrier layer that is provided inward of the adhesive layer, and a moisture barrier layer that is provided outward of the gas barrier layer.

### BACKGROUND

### 1. Technical Field

The present invention relates to a technique for a liquid container.

### 2. Related Art

An ink tank that includes a casing and a bag that is housed in the casing and has a spout is known (see, for example, Japanese Patent No. 4555550). Also, techniques for forming a multi-layered container that includes a gas barrier layer and a moisture barrier layer so as to obtain an air-tight and liquid-tight bag-like container are known (for example, Japanese Patents Nos. 4555550, 3896820, 4920422, and 4468018).

Japanese Patent No. 4555550, Japanese Patent No. 3896820, Japanese Patent No. 4920422, and Japanese Patent No. 4468018 are the examples of related arts.

For the multi-layered container, when an adhesive layer for bonding adjacent layers is used, the following problems may occur depending on the position at which the adhesive layer is formed. Specifically, when a liquid that contains an organic solvent as the main solvent is contained in the container, there are cases where the organic solvent in the container evaporates and moves to the outside, and the evaporated organic solvent reaches the adhesive layer. In this case, the solvent component of the adhesive layer is dissolved by the evaporated organic solvent, which may reduce the function (bonding function) of the adhesive layer. When the function of the adhesive layer is reduced, delamination occurs, which may reduce the impact resistance of the container.

### SUMMARY

The present invention has been made to solve at least one of the problems described above, and can be implemented as the following aspects or application examples.

(1) According to an aspect of the invention, a liquid container for supplying a liquid to a liquid consumption apparatus is provided. The liquid container includes: a liquid containing portion in which a containing space for containing the liquid is formed, the liquid containing portion including a flexible inner bag that is in contact with the containing space, and a flexible outer bag that is located outside of the inner bag; a connection portion that is detachable from the liquid consumption apparatus, and allows the liquid contained in the liquid containing portion to flow into the liquid consumption apparatus; and a housing box that houses the liquid containing portion. The liquid containing portion forms a layer structure in which a plurality of layers are disposed from the inside toward the outside. The layer structure includes an adhesive layer, a gas barrier layer that is provided inward of the adhesive layer, and a moisture barrier layer that is provided outward of the gas barrier layer.

According to this aspect, even when the liquid containing portion contains a liquid that contains an organic solvent as the main solvent, the gas barrier layer is located inward of the adhesive layer, and thus it is possible to prevent the organic solvent from moving to the outside of the gas barrier layer even if the organic solvent evaporates. Accordingly, the possibility of the evaporated organic solvent reaching the adhesive layer can be reduced, and thus a reduction (deterioration) in the function of the adhesive layer can be suppressed. Here, the liquid that contains an organic solvent as the main solvent may produce an unintended substance when mixed with moisture that has entered from the outside. According to this aspect, because the liquid containing portion includes the moisture barrier layer, it is possible to prevent moisture from being entered from the outside, and thus the production of an unintended substance can be suppressed. Also, in the case where a material that has high affinity for water is used to form the gas barrier layer, the gas barrier layer may absorb moisture when the surrounding region of the gas barrier layer has high levels of moisture, and the gas barrier performance may be reduced. According to this aspect, because the moisture barrier layer is provided outward of the gas barrier layer, it is possible to prevent moisture from being entered from the outside and from reaching the gas barrier layer. Accordingly, it is possible to prevent a reduction in the gas barrier performance of the gas barrier layer.

(2) In the liquid container according to the above aspect, the moisture barrier layer may be at least either a deposition film or a metal foil. According to this aspect, the moisture barrier layer can be formed using at least either a deposition film or a metal foil.

(3) In the liquid container according to the above aspect, the deposition film may be formed by any one of a silica deposition film layer obtained by depositing silica on a base substrate, an alumina deposition film layer obtained by depositing aluminum oxide on a base substrate, and an aluminum deposition film layer obtained by depositing aluminum on a base substrate. According to this aspect, the deposition film can be formed by any one of a silica deposition film layer, an alumina deposition film layer, and an aluminum deposition film layer.

(4) In the liquid container according to the above aspect, the metal foil may be an aluminum foil. According to this aspect, an aluminum foil can be used as the metal foil.

(5) In the liquid container according to the above aspect, the gas barrier layer may be made of a synthetic resin that contains an ethylene vinyl alcohol copolymer. According to this aspect, the gas barrier layer can be formed using a synthetic resin that contains an ethylene vinyl alcohol copolymer.

(6) In the liquid container according to the above aspect, in the layer structure, the adhesive layer may not be provided between an inner most layer that is in contact with the containing space and the gas barrier layer. According to this aspect, it is possible to, even when the liquid containing portion contains a liquid that contains an organic solvent as the main solvent, suppress a reduction in the function of the adhesive layer caused by an evaporated organic solvent.

(7) In the liquid container according to the above aspect, the layer structure includes, between the innermost layer and a layer including the gas barrier layer, a co-extruded layer in which a plurality of layers are stacked through co-extrusion. According to this aspect, in the co-extruded layer, a plurality of layers can be stacked without forming an adhesive layer, and it is therefore possible to suppress a reduction in the function of the adhesive layer caused by an evaporated organic solvent.

(8) In the liquid container according to the above aspect, the layer structure may include a heat seal layer that is provided inward of the gas barrier layer. According to this aspect, the heat seal layer can be disposed inward of the gas barrier layer.

(9) In the liquid container according to the above aspect, the inner bag may be formed using a monolayer that is an inner heat seal layer serving as the heat seal layer, and the outer bag may include, in order from the inside toward the outside, an outer heat seal layer that serves as the heat seal layer, the gas barrier layer, and the moisture barrier layer. According to this aspect, the outer bag can have gas barrier properties and moisture barrier properties while the inner bag is formed using a monolayer, which is a heat seal layer.

(10) In the liquid container according to the above aspect, the inner heat seal layer may be thicker than the outer heat seal layer . According to this aspect, the inner heat seal layer is thicker than the outer heat seal layer, and it is therefore possible to reduce the possibility of the inner bag being damaged due to liquid pressure when the containing space is filled with a liquid.

(11) In the liquid container according to the above aspect, the inner bag may include, in order from the inside toward the outside, a first inner heat seal layer that serves as the heat seal layer, the gas barrier layer, and a second inner heat seal layer that serves as the heat seal layer, and the outer bag may include, in order from the inside toward the outside, an outer heat seal layer that serves as the heat seal layer, and the moisture barrier layer. According to this aspect, it is possible to impart gas barrier properties to the inner bag, and also impart moisture barrier properties to the outer bag.

(12) In the liquid container according to the above aspect, the liquid containing portion may include: a first film member that is formed by a first inner film that constitutes the inner bag, and a first outer film that constitutes the outer bag; and a second film member that is formed by a second inner film that constitutes the inner bag, and a second outer film that constitutes the outer bag. An outer peripheral portion of the first film member and an outer peripheral portion of the second film member may be fuse-bonded together. According to this aspect, the liquid containing portion can be easily formed by using the first film member and the second film member.

(13) In the liquid container according to the above aspect, the layer structure may include a surface protection layer as the outermost layer. According to this aspect, the liquid containing portion includes the surface protection layer at the outermost position, and it is therefore possible to reduce the possibility of the liquid containing portion being damaged.

(14) In the liquid container according to the above aspect, the layer structure may include an intermediate protection layer that sandwiches at least one of the gas barrier layer and the moisture barrier layer. According to this aspect, the gas barrier layer or the moisture barrier layer can be protected by the intermediate protection layer.

The present invention may be implemented in various other forms other than the liquid container. For example, the present invention may be implemented as a method for manufacturing a liquid container, a liquid consumption system that includes a liquid container and a liquid consumption apparatus, or the like.

### BRIEF DESCRIPTION OF THE DRAWINGS

The invention will be described with reference to the accompanying drawings, wherein like numbers reference like elements.

FIG. 1 is a schematic diagram showing a liquid consumption system according to a first embodiment.

FIG. 2 is a perspective view of a liquid container and one end portion side of a first tube.

FIG. 3 is a perspective view of an attachment portion.

FIG. 4 is a perspective view of a liquid container.

FIG. 5 is a perspective view of a housing box.

FIG. 6 is a perspective view of a liquid housing body.

FIG. 7 is a schematic diagram illustrating a liquid containing portion.

FIG. 8 is a schematic diagram of a first film member when viewed from the front.

FIG. 9 is a schematic diagram of a second film member when viewed from the front.

FIG. 10 is a diagram illustrating a layer structure of a liquid containing portion.

FIG. 11 is a diagram illustrating a layer structure of a liquid container according to a second embodiment.

### DESCRIPTION OF EXEMPLARY EMBODIMENTS

### A. First Embodiment

### A-1: Configuration of Liquid Consumption System

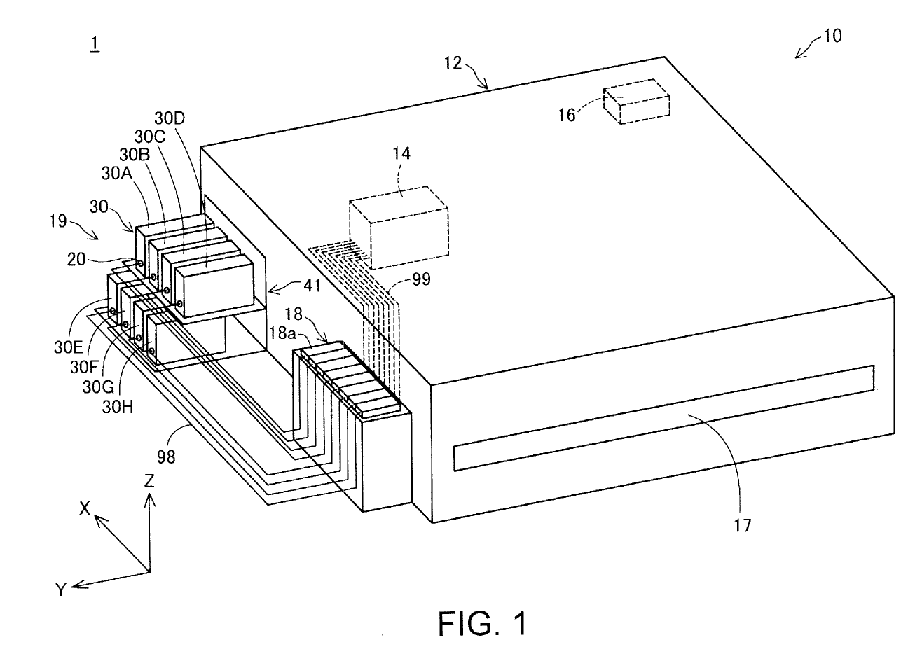

FIG. 1 is a schematic diagram of a liquid consumption system 1 according to a first embodiment of the present invention. In FIG. 1, three mutually orthogonal spatial axes, namely, an X axis, a Y axis, and a Z axis, are shown. The direction that extends along the X axis will be defined as the X axis direction, the direction that extends along the Y axis will be defined as the Y axis direction, and the direction that extends along the Z axis will be defined as the Z axis direction. In an attached state in which a liquid container 30 is attached to an attachment portion 20, which will be described later, the gravity direction (downward direction) will be defined as the −Z axis direction, and the counter gravity direction (upward direction) will be defined as +Z axis direction. Likewise, in the attached state, one side of the X axis direction will be defined as the +X axis direction, and the other side of the X axis direction will be defined as the −X axis direction. In the attached state, the liquid consumption system 1 is installed on a plane (X-Y plane) that is parallel to the X axis direction and the Y axis direction. The X axis, the Y axis, and the Z axis in the attached state are also shown in the other diagrams described below where necessary.

The liquid consumption system 1 includes a liquid consumption apparatus 10, liquid containers 30, a main shelf 19, and a sub shelf 18. The liquid consumption apparatus 10 is, for example, an inkjet textile printing machine that ejects ink, which is an example of a liquid, to a medium such as paper, a film, or a fabric product so as to perform recording (printing). According to another embodiment, the liquid consumption apparatus 10 may be a printer that ejects ink onto paper so as to perform recording (printing).

Eight liquid containers 30 for the liquid consumption apparatus 10 are provided. The eight liquid containers 30 contain liquids (inks) of different colors. Where it is necessary to make a distinction between the eight liquid containers 30, reference numerals 30A to 30H will be used. A liquid container 30A contains a cyan (C) liquid. A liquid container 30B contains a magenta (M) liquid. A liquid container 30C contains a yellow (Y) liquid. A liquid container 30D contains a black (K) liquid. A liquid container 30E contains a red (R) liquid. A liquid container 30F contains a blue (B) liquid. A liquid container 30G contains an orange (O) liquid. A liquid container 30H contains a gray (LK) liquid. According to another embodiment, the number of liquid containers 30 may be less than 8, or may be greater than 8.

The main shelf 19 is provided on the outside of the liquid consumption apparatus 10, and the eight liquid containers 30 are disposed thereon. The main shelf 19 has a two-level configuration, with the liquid containers 30A to 30D being disposed on the upper level, and the liquid containers 30E to 30H being disposed on the lower level. In the main shelf 19, one end portions of first tubes 98, which will be described later, are provided.

Eight sub tanks 18a are disposed on the sub shelf 18. The eight sub tanks 18a are provided so as to correspond to the eight liquid containers 30 A to 30H. The liquid containers 30A to 30H and the corresponding sub tanks 18a are in communication with each other via flexible first tubes 98. Eight first tubes 98 are provided so as to correspond to the liquid containers 30A to 30H. The liquids contained in the liquid containers 30A to 30H are supplied to the corresponding sub tanks 18a through the first tubes 98 by a vacuum mechanism (not shown) provided in the liquid consumption system 1, the vacuum mechanism being, for example, a pump (not shown) disposed on the sub shelf 18.

The liquid consumption apparatus 10 includes an outer shell 12, a liquid consumption portion 14, a control portion 16, first tubes 98, attachment portions 20, and second tubes 99. The outer shell 12 has a substantially rectangular parallelepiped outer shape. The outer shell 12 forms the outer surface of the liquid consumption apparatus 10.

The liquid consumption portion 14 is disposed within the outer shell 12. The liquid consumption portion 14 is in communication with the sub tanks 18a via the flexible second tubes 99 that are provided corresponding to the sub tanks 18a. Liquid is supplied to the liquid consumption portion 14 via the second tubes 99. In the present embodiment, the liquid contained in the sub tanks 18a is supplied to the liquid consumption portion 14 via the second tubes 99 by a pressurizing mechanism such as, for example, a pump (not shown) provided in the liquid consumption apparatus 10. The liquid consumption portion 14 includes an ejection head for ejecting liquid onto a medium such as a fabric product. The liquid consumption portion 14 is reciprocatingly moved in the Y axis direction by a driving mechanism (not shown) provided in the liquid consumption apparatus 10. The liquid consumption portion 14 is reciprocatingly moved in the Y axis direction while ejecting liquid, and the medium is moved in the outer shell 12 from the +X axis direction side toward the −X axis direction side by a conveyance mechanism (not shown) provided in the liquid consumption apparatus 10. The liquid is thereby ejected onto the medium. The medium onto which a liquid has been ejected is discharged to the outside of the outer shell 12 through a discharge outlet 17 provided in a surface (front surface) of the outer shell 12 that is located on the −X axis direction side. According to another embodiment, the liquid consumption portion 14 may be a line head that is not reciprocatingly moved and is fixed.

The control portion 16 is disposed within the outer shell 12. The control portion 16 controls the operations of the liquid consumption apparatus 10. For example, the control portion 16 controls the operations of the driving mechanism and the conveyance mechanism described above. Also, the control portion 16 is electrically connected to the liquid containers 30, and is therefore capable of exchanging various types of information with the liquid containers 30. The various types of information may include, for example, the liquid color information of each liquid container 30, information indicating whether or not each liquid container 30 is attached to the liquid consumption apparatus 10, and the like.

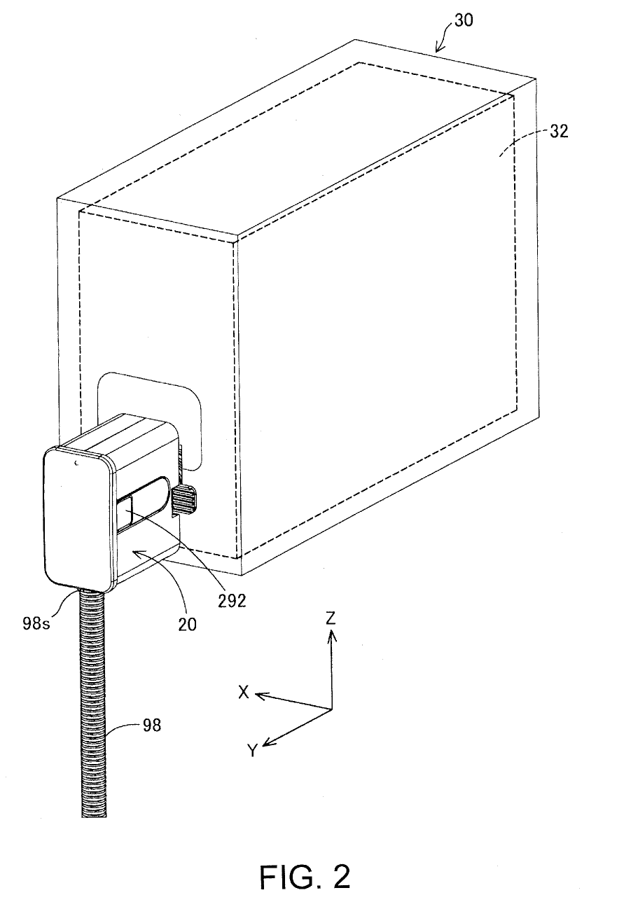

FIG. 2 is a perspective view of a liquid container 30 and one end portion 98s side of a first tube 98. FIG. 2 shows an attached state in which the liquid container 30 is attached to an attachment portion 20. The attachment portion 20 is connected to the one end portion 98s of the first tube 98. The attachment portion 20 is detachably attached to the liquid container 30. Specifically, the attachment portion 20 is moved toward the liquid container 30 disposed on the main shelf 19 (FIG. 1), and the attachment portion 20 is attached to the liquid container 30. The direction in which the attachment portion 20 is attached to the liquid container 30 is the −Y axis direction, and the direction in which the attachment portion 20 is detached from the liquid container 30 is the +Y axis direction. The attachment direction is based on a direction immediately before the attachment portion 20 is attached to the liquid container 30, and the detachment direction is based on a direction immediately after an operation to detach the attachment portion 20 from the liquid container 30. That is, a direction (attachment direction) in which the liquid container 30 is moved relative to the attachment portion 20 when the liquid container 30 is attached to the attachment portion 20 is the +Y axis direction. Also, a direction (detachment direction) in which the liquid container 30 is moved relative to the attachment portion 20 when the liquid container 30 is detached from the attachment portion 20 is the −Y axis direction.

The attachment portion 20 includes releasing portions 292 on both sides in the X axis direction (only one disengagement portion 292 is shown in FIG. 2). As a result of the releasing portions 292 being pressed, the engagement between the attachment portion 20 and the liquid container 30 is released, and the attachment portion 20 can be detached from the liquid container 30. In the attached state, a liquid contained in a liquid containing portion 32 included in the liquid container 30 is supplied to the attachment portion 20. The liquid supplied to the attachment portion 20 flows through the first tube 98.

### A-2: Configuration of Attachment Portion

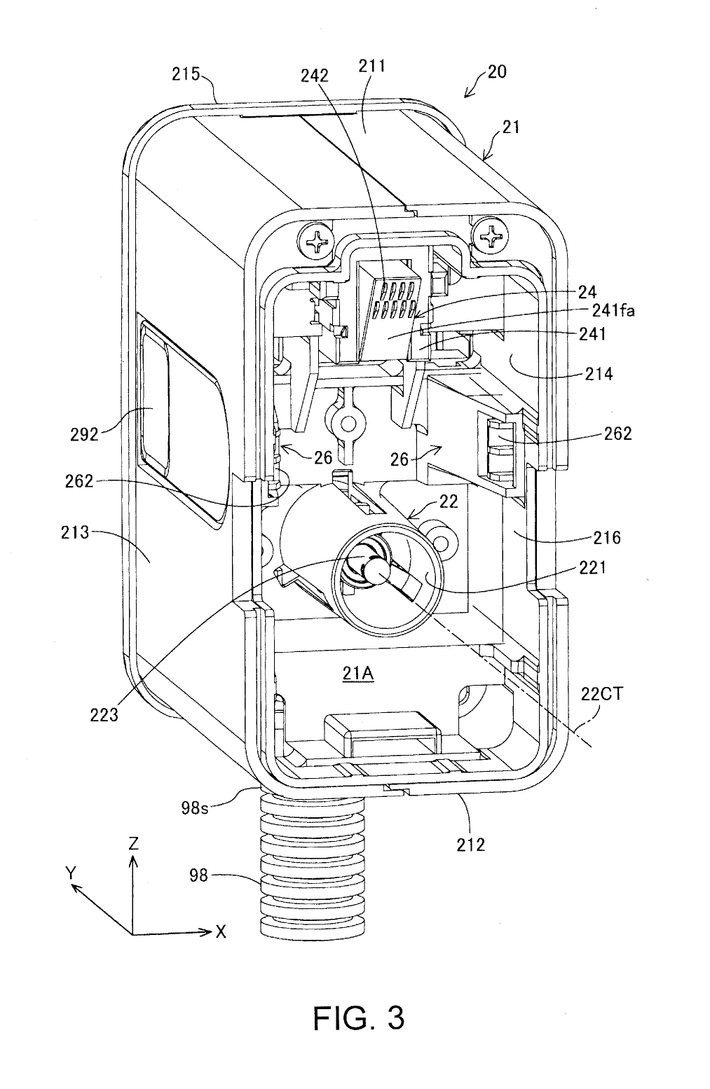

FIG. 3 is a perspective view of an attachment portion 20. For the sake of ease of understanding, FIG. 3 also shows one end portion 98s side of a first tube 98.

The attachment portion 20 includes an attachment portion outer shell 21 that forms its outer surface. The attachment portion outer shell 21 has a substantially rectangular parallelepiped outer shape. It can be said that the attachment portion outer shell 21 is a recess portion that has an opening on the −Y axis direction side thereof. The attachment portion outer shell 21 includes an attachment portion first surface (attachment portion first wall) 211, an attachment portion second surface (attachment portion second wall) 212, an attachment portion third surface (attachment portion third wall) 213, an attachment portion fourth surface (attachment portion fourth wall) 214, an attachment portion fifth surface (attachment portion fifth wall) 215, and an opening portion 216.

In the attached state in which a liquid container 30 is attached to the attachment portion 20, the attachment portion first surface 211 forms an upper surface, and the attachment portion second surface 212 forms a bottom surface. Also, the attachment portion third surface 213 forms one side surface, and the attachment portion fourth surface 214 forms another side surface. The attachment portion fifth surface 215 forms a recess bottom portion. The opening portion 216 opposes the attachment portion fifth surface 215, and defines an opening through which a portion of the liquid container 30 passes during attachment. The attachment portion first surface 211 and the attachment portion second surface 212 oppose each other in the Z axis direction. The attachment portion third surface 213 and the attachment portion fourth surface 214 oppose each other in the X axis direction. The attachment portion fifth surface 215 and the opening portion 216 oppose each other in the Y axis direction. The attachment portion first surface 211, the attachment portion second surface 212, the attachment portion third surface 213, the attachment portion fourth surface 214, and the attachment portion fifth surface 215 define a housing space 21A that houses a portion of the liquid container.

The attachment portion 20 further includes a liquid introducing portion 22, an apparatus-side electric mechanism portion 24, and engagement portions 26. The liquid introducing portion 22, the apparatus-side electric mechanism portion 24, and the engagement portions 26 are disposed in the housing space 21A that forms the interior of the attachment portion 20.

The liquid introducing portion 22 includes a liquid introducing needle 223 and an attachment portion-side tubular portion 221. The liquid introducing needle 223 has a central axis 22CT that extends in the Y axis direction. The liquid introducing needle 223 is hollow inside, and internally includes a flow path through which a liquid flows. In the attached state, the liquid introducing needle 223 is connected to a liquid supply portion, which will be described later, of the liquid container 30, and the liquid from the liquid supply portion flows into the inside of the liquid introducing needle 223. The proximal end portion (+Y axis direction-side end portion) of the liquid introducing needle 223 is in communication with the first tube 98.

The attachment portion-side tubular portion 221 surrounds an outer circumference of the liquid introducing needle 223 about the central axis 22CT. Also, the attachment portion-side tubular portion 221 houses the liquid introducing needle 223. The attachment portion-side tubular portion 221 has an opening in its −Y axis direction-side end portion. The central axis of the attachment portion-side tubular portion 221 is the same as the central axis of the liquid introducing needle 223.

The apparatus-side electric mechanism portion 24 includes electric connection portions 242 that serve as terminals, and a pedestal 241 on which the electric connection portions 242 are disposed. In the attached state, the apparatus-side electric mechanism portion 24 is located on the counter gravity direction side (+Z axis direction side) relative to the liquid introducing portion 22.

Each electric connection portion 242 is a plate-like metal member and is elastically deformable. A portion of each electric connection portion 242 is exposed from a surface 241fa of the pedestal 241. The normal vector of the surface 241fa is a direction that includes a −Z axis direction component and a −Y axis direction component. Nine electric connection portions 242 are provided. The electric connection portions 242 are electrically connected to the control portion 16 (FIG. 1) via wires (not shown).

Two engagement portions 26 are provided. In the attached state of the liquid container 30, each engagement portion 26 includes an engaging claw 262 at its −Y axis direction-side end portion. As a result of the engagement portions 26 being engaged with a portion of the liquid container 30, the engagement portions 26 restrict movement of the liquid container 30 relative to the attachment portion 20 at least in the Y axis direction.

As a result of the releasing portions 292 provided in the attachment portion third surface 213 and the attachment portion fourth surface 214 (only one releasing portion 292 is shown in the diagram) being pressed, the engaging claws 262 are displaced outward of the housing space 21A, and the engagement between the engagement portions 26 and the liquid container 30 is thereby released.

### A-3: Configuration of Liquid Container

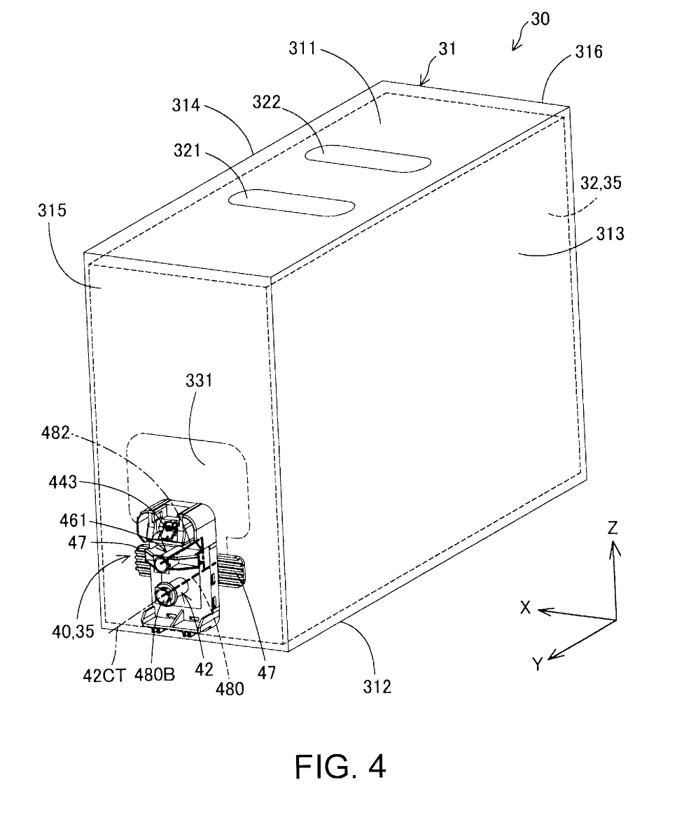

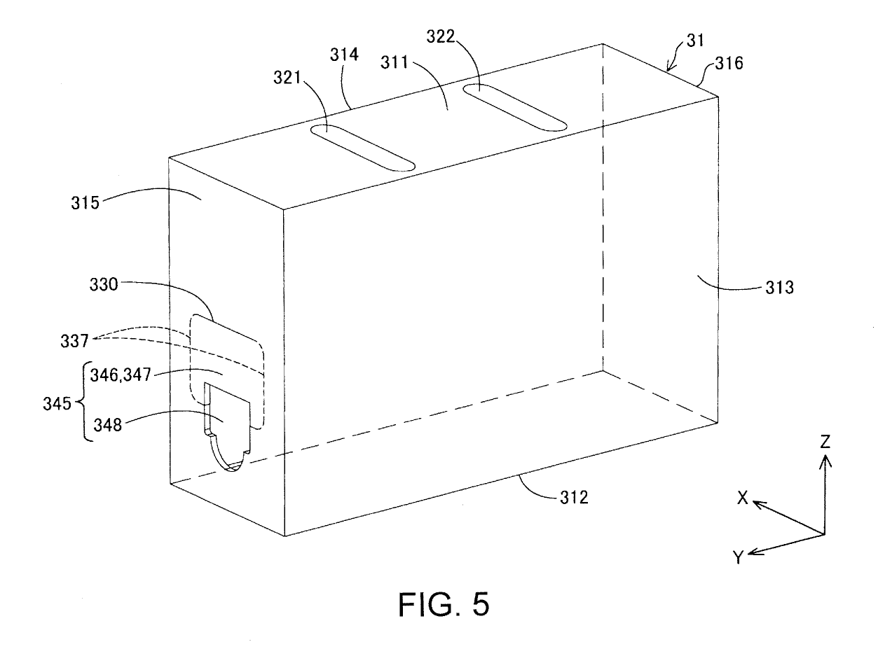

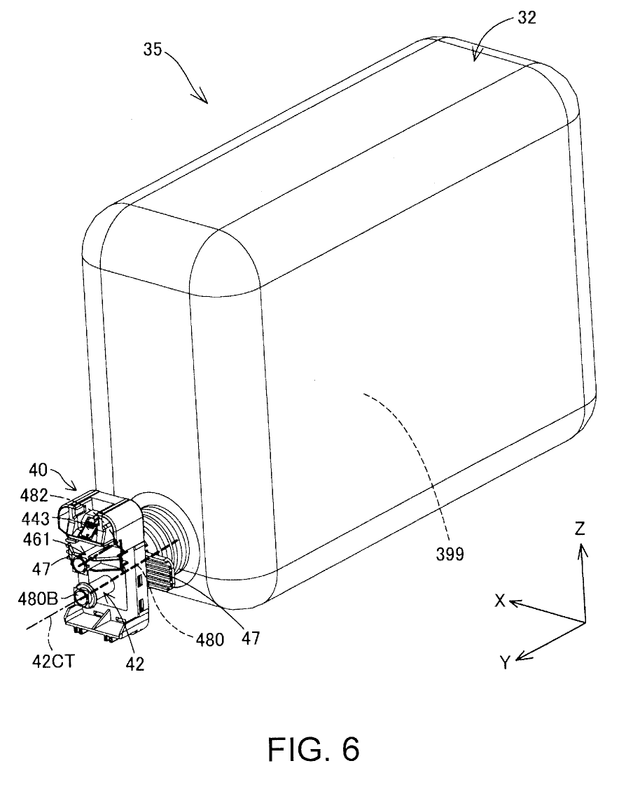

FIG. 4 is a perspective view of a liquid container 30. FIG. 5 is a perspective view of a housing box 31. FIG. 6 is a perspective view of a liquid housing body 35.

The liquid container 30 (FIG. 4) includes a liquid housing body 35 and a housing box 31. The liquid housing body 35 (FIG. 6) includes a liquid containing portion 32 and a connection portion 40. The liquid containing portion 32 internally includes a containing space 399. The containing space 399 (FIG. 6) contains a liquid (ink) that is supplied to the liquid consumption apparatus 10 (specifically, the attachment portion 20). In the present embodiment, a dye ink is used as the liquid. The liquid containing portion 32 is a flexible bag-like body, and is filled with a liquid. The volume of the liquid containing portion 32 decreases gradually as the liquid contained in the liquid containing portion 32 is consumed. The liquid containing portion 32 is in communication with a liquid supply portion 42 of the connection portion 40. The liquid housing body 35 is replaced with a new one when the liquid contained in the liquid containing portion 32 is consumed and the remaining amount reaches zero or almost zero. The liquid containing portion 32 will be described in detail later.

The connection portion 40 (FIG. 6) is detachable from the liquid consumption apparatus 10 (specifically, the attachment portion 20). The connection portion 40 allows the liquid contained in the liquid containing portion 32 to flow into the liquid consumption apparatus 10 (specifically, the attachment portion 20). The connection portion 40 includes a liquid supply portion 42, a pair of restricting portions 47, a circuit board 443, a liquid injection portion 461, a supply flow path 480, and an injection flow path 482. In the connection portion 40, the X axis direction corresponds to the width direction, the Y axis direction corresponds to the depth direction, and the Z axis direction corresponds to the height direction.

The supply flow path 480 is a flow path that allows the liquid containing portion 32 and the liquid supply portion 42 to be in communication with each other. The liquid supply portion 42 is a tubular member that extends in the Y axis direction, and has a central axis 42CT that is parallel to the Y axis direction. The liquid supply portion 42 includes a liquid outlet 480B at one end thereof. The liquid supply portion 42 allows the liquid in the liquid containing portion 32 supplied via the supply flow path 480 to flow to the outside (in the present embodiment, the liquid introducing needle 223) via the liquid outlet 480B. The liquid supply portion 42 is housed in the housing box 31 so as to be capable of being removed from the inside of the housing box 31 to the outside via a removal opening portion 345 (FIG. 5), which will be described later.

The circuit board 443 (FIG. 6) includes a plurality of terminals (nine terminals in the present embodiment) that are provided on its surface, and a storage device that is provided on its back surface. The storage device stores, for example, information (for example, liquid color information, information regarding the remaining amount of liquid) regarding the liquid container 30. In the attached state, the nine terminals of the circuit board 443 are in contact with the corresponding electric connection portions 242 (FIG. 3). Accordingly, signals can be exchanged between the control portion 16 (FIG. 1) and the storage device.

In a removed state in which the liquid supply portion 42 has been removed from the housing box 31, the pair of restricting portions 47 (FIG. 4) are located on a housing box fifth surface 315, which serves as a removal opening forming wall, sandwiching an axis direction (Y axis direction) that extends along the central axis 42CT. Accordingly, the pair of restricting portions 47 restrict movement of the liquid supply portion 42 in the axis direction (Y axis direction) that extends along the central axis 42CT of the liquid supply portion 42.

The liquid injection portion 461 is a cylindrical member that extends in the Y axis direction. The liquid injection portion 461 forms a portion of the injection flow path 482 that is joined to the supply flow path 480. The injection flow path 482 is a flow path that allows a liquid to flow into the liquid containing portion 32 from the outside. As a result of a liquid being injected from the liquid injection portion 461, the liquid can be injected into the liquid containing portion 32 through the injection flow path 482. In the direction (injection direction) in which the liquid flows from the liquid injection portion 461 into the liquid containing portion 32, the downstream side of the injection flow path 482 is joined to the supply flow path 480.

The housing box 31 (FIG. 5) houses the liquid containing portion 32. The housing box 31 has a substantially rectangular parallelepiped outer shape. In the present embodiment, the housing box 31 is made from corrugated cardboard. The housing box 31 is made of, for example, a material composed mainly of cellulose. According to another embodiment, the housing box 31 may be formed of another material (for example, a synthetic resin such as polypropylene or polyethylene). The housing box 31 includes a housing box first surface (housing box first wall) 311, a housing box second surface (housing box second wall) 312, a housing box third surface (housing box third wall) 313, a housing box fourth surface (housing box fourth wall) 314, a housing box fifth surface (housing box fifth wall) 315, and a housing box sixth surface (housing box sixth wall) 316.

In the attached state of the liquid container 30, the housing box first surface 311 forms an upper surface, and the housing box second surface 312 forms a bottom surface. Also, the housing box third surface 313 forms one side surface, and the housing box fourth surface 314 forms another side surface. The housing box fifth surface 315 forms a front surface that faces the attachment portion 20, and the housing box sixth surface 316 forms a rear surface. The housing box first surface 311 and the housing box second surface 312 oppose each other in the Z axis direction. The housing box third surface 313 and the housing box fourth surface 314 oppose each other in the X axis direction. The housing box fifth surface 315 and the housing box sixth surface 316 oppose each other in the Y axis direction.

In the removed state, the connection portion 40 (FIG. 4) is inserted through the housing box fifth surface 315. Accordingly, a portion of the connection portion 40 is exposed to the outside of the housing box 31. In an unused state such as that when the liquid container 30 is being transported, the entire connection portion 40 is housed in the housing box 31. For example, the connection portion 40 can be housed in the housing box 31 by opening an opening/closing portion 346.

In the housing box fifth wall 315 (FIG. 5), a removal opening portion 345 is formed that functions as an opening portion through which the liquid supply portion 42 can be removed from the housing box 31 in a state in which the liquid containing portion 32 is housed within the housing box 31. The removal opening portion 345 extends through the housing box fifth wall 315 in the Y axis direction. The removal opening portion 345 includes an insertion opening portion 348, and an opening/closing opening portion 347 that is formed as a result of the opening/closing portion 346 being opened. The position at which the removal opening portion 345 is formed is not limited to the position described in the present embodiment, and the removal opening portion 345 may be formed in another wall of the housing box 31. Also, the shape and size of the insertion opening portion 348 and the opening/closing portion 346 are not limited to those described in the present embodiment.

The insertion opening portion 348 is a portion through which the connection portion 40 is inserted in the removed state. The insertion opening portion 348 is formed by removing a portion of the housing box fifth wall 315 following a slit formed in the housing box fifth wall 315 before the liquid container 30 is shipped as a product. The insertion opening portion 348 may be opened before the liquid container 30 is shipped as a product.

In the attached state, the opening/closing portion 346 is located above the insertion opening portion 348 (on the counter gravity direction side relative to the insertion opening portion 348). The opening/closing portion 346 is a plate-like member that is capable of being opened/closed about an upper edge 330. The opening/closing portion 346 includes the upper edge 330 in which a fold is formed, and side edges 337 that are located at both edge portions of the upper edge 330 and from which the housing box fifth wall 315 is separated. In the side edges 337, slits are formed so that the housing box fifth wall 315 can be easily separated therefrom. In FIG. 5, the side edges 337 are shown by dotted lines. When removing the liquid supply portion 42 from the inside of the housing box 31 to the outside, the opening/closing opening portion 347 is formed by opening the opening/closing portion 346 toward the outer side of the housing box 31 about the upper edge 330. Accordingly, the liquid supply portion 42 can be removed to the outside of the housing box 31, with the opening area of the removal opening portion 345 being widened. After the liquid supply portion 42 has been removed, the opening/closing portion 346 is closed and constitutes a portion of the housing box fifth wall 315. The direction in which the liquid supply portion 42 is removed from the inside of the housing box 31 to the outside via the removal opening portion 345 in a state in which the liquid containing portion 32 is housed within the housing box 31 is substantially the +Y axis direction. The direction in which the liquid supply portion 42 is housed in the housing box 31 from the outside via the removal opening portion 345, in a state in which the liquid containing portion 32 is housed, is substantially the −Y axis direction. As described above, the housing box fifth wall 315 includes the removal opening portion 345 for removing the liquid supply portion 42 from the inside of the housing box 31 to the outside in a state in which the liquid containing portion 32 is housed in the housing box 31.

Accordingly, the housing box fifth wall 315 may also be referred to as “removal opening forming wall 315”.

The housing box 31 (FIG. 5) further includes grip opening portions 321 and 322 that are formed for gripping, in the housing box first surface 311. The grip opening portions 321 and 322 each have an oblong shape that is elongated in the width direction (X axis direction). The user can easily carry the liquid container 30 by inserting his/her fingers into the grip opening portions 321 and 322 and gripping the housing box first surface 311. The grip opening portions 321 and 322 may be formed in another surface (for example, the housing box fifth surface 315 and the housing box sixth surface 316).

### A-4. Detailed Configuration of Liquid Containing Portion

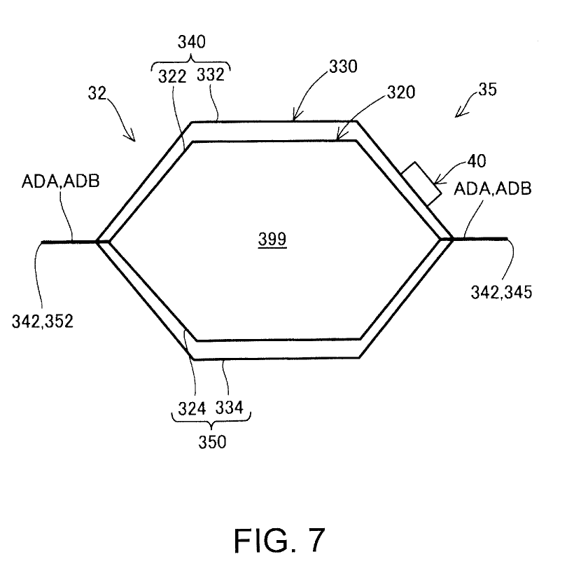

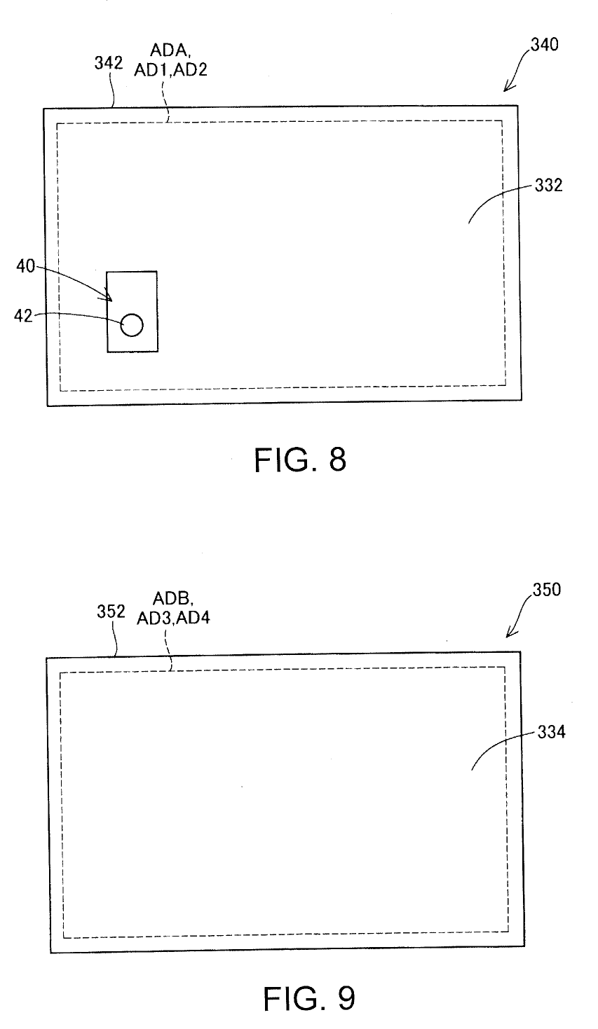

FIG. 7 is a schematic diagram illustrating the liquid containing portion 32. FIG. 8 is a schematic diagram of a first film member when viewed from the front. FIG. 9 is a schematic diagram of a second film member when viewed from the front. For the sake of ease of understanding, the connection portion 40 is also illustrated in FIGS. 7 and 8. FIG. 7 schematically shows a state in which the liquid containing portion 32 is filled with a liquid and expanded. FIGS. 8 and 9 schematically show a state in which the liquid containing portion 32 contains no liquid.

The liquid containing portion 32 (FIG. 7) is a double bag, and includes an inner bag 320 that is in contact with the containing space 399 on inside of the inner bag 320, and an outer bag 330 that is located outside the inner bag 320. The inner bag 320 and the outer bag 330 are both flexible. Also, the liquid containing portion 32 is a pillow-type bag-like body. To be specific, the liquid containing portion 32 includes a first film member 340 and a second film member 350. An outer peripheral portion ADA of the first film member 340 and an outer peripheral portion ADB of the second film member 350 are thermally fuse-bonded. The outer peripheral portions ADA and ADB may be portions that include outer edges 342 and 352 that respectively form the contours of the film members 340 and 350, or may be portions inward of the outer edges 342 and 352. In the present embodiment, the outer peripheral portions ADA and ADB that are thermally fuse-bonded to each other are located inward of the outer edges 342 and 352.

The first film member 340 is formed by a first inner film 322 that constitutes a portion of the inner bag 320, and a first outer film 332 that constitutes a portion of the outer bag 330. As shown in FIG. 8, in a state before the liquid containing portion 32 is filled with a liquid, the first film member 340 has a substantially rectangular outer shape. The first film member 340 is formed by thermally fuse-bonding an outer peripheral portion AD1 of the first inner film 322 (FIG. 7) and an outer peripheral portion AD2 of the first outer film 332. The outer peripheral portion AD1 and the outer peripheral portion AD2 may be the same regions as the outer peripheral portion ADA of the first film member 340, or may be different regions.

The second film member 350 (FIG. 7) is formed by a second inner film 324 that constitutes another portion of the inner bag 320, and a second outer film 334 that constitutes another portion of the outer bag 330. As shown in FIG. 9, in a state before the liquid containing portion 32 is filled with a liquid, the second film member 350 has a substantially rectangular outer shape. The second film member 350 is formed by thermally fuse-bonding an outer peripheral portion AD3 of the second inner film 324 (FIG. 7) and an outer peripheral portion AD4 of the second outer film 334.

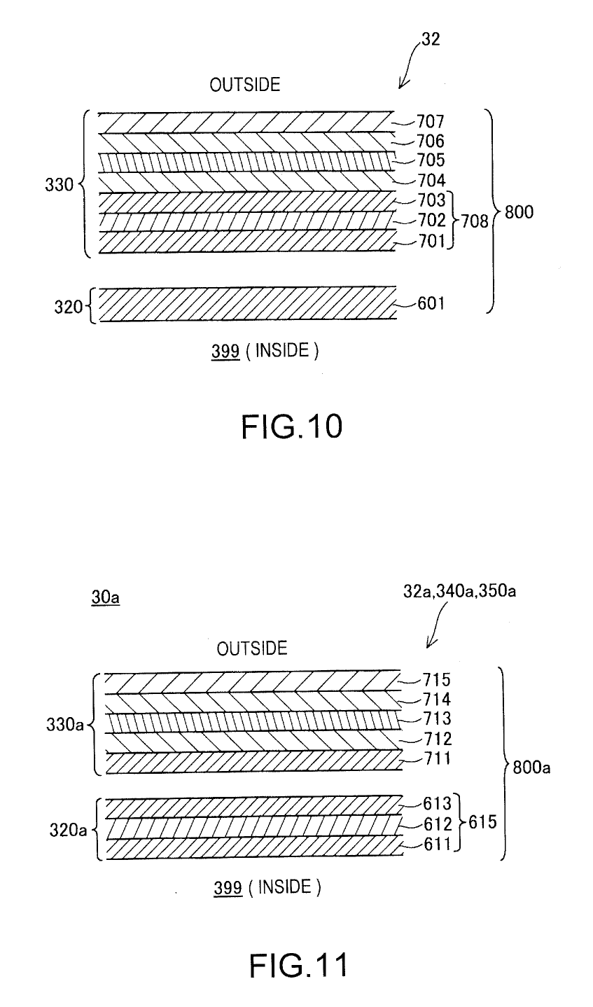

FIG. 10 is a diagram illustrating a layer structure of the liquid containing portion 32. The liquid containing portion 32 forms a layer structure 800 in which a plurality of layers 601 and 701 to 707 are disposed from the inside (the containing space 399 side) toward the outside. The first film member 340 (FIG. 7) and the second film member 350 (FIG. 7) have the same layer structure 800.

The layer structure 800 (FIG. 10) includes, in order from the inside toward the outside, an inner heat seal layer 601 that serves as a heat seal layer, an outer heat seal layer 701 that serves as a heat seal layer, a gas barrier layer 702, an intermediate layer 703, a first adhesive layer 704 that serves as an adhesive layer, a moisture barrier layer 705, a second adhesive layer 706 that serves as an adhesive layer, and a surface protection layer 707. The inner bag 320 is composed of a monolayer which is the inner heat seal layer 601. The outer bag 330 has a layer structure in which the outer heat seal layer 701, the gas barrier layer 702, the intermediate layer 703, the first adhesive layer 704, the moisture barrier layer 705, the second adhesive layer 706, and the surface protection layer 707 are stacked in this order from the inside toward the outside. As long as the outer bag 330 includes, in order from the inside toward the outside, the outer heat seal layer 701, the gas barrier layer 702, and the moisture barrier layer 705, the other layers may be omitted. The outer heat seal layer 701, the gas barrier layer 702, and the intermediate layer 703 constitute a co-extruded layer (multilayer film) 708 that has been formed through co-extrusion.

The inner heat seal layer 601 and the outer heat seal layer 701 are both made of a synthetic resin that is heat sealable with an adjacent member (layer). As the heat sealable synthetic resin, it is possible to use, for example, polyethylene or polypropylene. In the present embodiment, the inner heat seal layer 601 and the outer heat seal layer 701 are both made of polyethylene. The outer peripheral portion ADA of the first inner film 322 and the outer peripheral portion ADB of the second inner film 324 are thermally fuse-bonded to each other by an inner heat seal layer 601 that constitutes the first inner film 322 (FIG. 7) and an inner heat seal layer 601 that constitutes the second inner film 324 (FIG. 7). Also, in the first film member 340, the outer peripheral portion AD1 of the first inner film 322 and the outer peripheral portion AD2 of the first outer film 332 are thermally fuse-bonded to each other by the inner heat seal layer 601 and the outer heat seal layer 701. Also, in the second film member 350, the outer peripheral portion AD3 of the second inner film 324 and the outer peripheral portion AD4 of the second outer film 334 are thermally fuse-bonded to each other by the inner heat seal layer 601 and the outer heat seal layer 701.

The inner heat seal layer 601 is preferably thicker than the outer heat seal layer 701. For example, the inner heat seal layer 601 may have a thickness of 90 μm or more and 200 μm, and the outer heat seal layer 701 may have a thickness of 20 μm or more and 50 μm or less. By forming the inner heat seal layer 601 so as to be thicker than the outer heat seal layer 701, sealing properties (fuse-bonding strength) exhibited through heat sealing can be improved. With this configuration, it is possible to prevent the fuse-bonding portion of the inner heat seal layer 601 from separating due to liquid pressure when the containing space 399 is filled with a liquid, and thus the possibility of the inner bag 320 being damaged can be reduced.

The gas barrier layer 702 is a layer (film layer) for preventing the passage of gas. The gas barrier layer 702 is formed by, for example, a synthetic resin layer such as a film layer made of ethylene vinyl alcohol copolymer (EVOH), or a film layer containing EVOH. In the case where the liquid contained in the liquid containing portion 32 contains an organic solvent (for example, ketone or alcohol) as the main solvent, the organic solvent may vaporize and move from the inside toward the outside. With the inclusion of the gas barrier layer 702, it is possible to prevent the vaporized organic solvent from moving to the outside of the gas barrier layer 702.

The intermediate layer 703 is a film layer made of a synthetic resin such as polyethylene or polypropylene. The intermediate layer 703 is preferably a layer (synthetic resin layer) that has the same composition as that of the outer heat seal layer 701. The co-extruded layer 708 including the intermediate layer 703 and the outer heat seal layer 701 with the gas barrier layer 702 interposed therebetween is formed through co-extrusion. By using a synthetic resin that has the same composition as that of the outer heat seal layer 701, as the composition of the intermediate layer 703, deformation such as curling can be suppressed when forming the co-extruded layer (multilayer film) 708 through co-extrusion molding.

The first adhesive layer 704 is a layer that is provided between the intermediate layer 703 and the moisture barrier layer 705 so as to bond the intermediate layer 703 and the moisture barrier layer 705. The first adhesive layer 704 is a layer made of various types of adhesives, and is, for example, a layer made of an adhesive obtained by dissolving an adhesive resin in a solvent, such as an amino resin-based adhesive, a phenol resin-based adhesive, an epoxy-based adhesive, a polyurethane-based adhesive, or the like.

The moisture barrier layer 705 is a layer (film layer) for preventing the passage of moisture. The moisture barrier layer 705 prevents, for example, moisture from entering into the containing space 399 from the outside of the liquid containing portion 32, or moisture from moving from the inside toward the outside. The moisture barrier layer 705 is, for example, at least either a deposition film or a metal foil. As the deposition film, it is possible to use, for example, any one of a silica deposition film layer obtained by depositing silica on a base substrate, an alumina deposition film layer obtained by depositing aluminum oxide on a base substrate, and an aluminum deposition film layer obtained by depositing aluminum on a base substrate. The base substrate used for deposition may be made of a synthetic resin such as nylon or polyethylene terephthalate. As the metal foil, it is possible to use, for example, an aluminum foil made of aluminum.

The second adhesive layer 706 is a layer that is provided between the moisture barrier layer 705 and the surface protection layer 707 so as to bond the moisture barrier layer 705 and the surface protection layer 707. The second adhesive layer 706 is a layer made of various types of adhesives, and is for example, a layer made of an adhesive obtained by dissolving an adhesive resin in a solvent, such as an amino resin-based adhesive, a phenol resin-based adhesive, an epoxy-based adhesive, a polyurethane-based adhesive, or the like, as with the first adhesive layer 704.

The surface protection layer 707 is the outermost layer (film layer) provided to protect the liquid containing portion 32 from an external force (impact) applied from the outside. As the surface protection layer 707, it is possible to use a film made of a polyolefin-based resin, a polyester resin, a polyamide resin, an ethylene vinyl alcohol copolymer-based resin, or the like. Examples of the polyolefin-based resin include a polyethylene, a polypropylene, and an ethylene-vinyl acetate copolymer. Examples of the polyethylene include low density polyethylene (LDPE), and linear low density polyethylene (LLDPE). Examples of the polyester resin include polyethylene terephthalate, and polyethylene naphthalate. Examples of the polyamide resin include aliphatic polyamides such as nylon. In the present embodiment, a film layer made of nylon is used as the surface protection layer 707.

According to the first embodiment described above, the layer structure 800 of the liquid containing portion 32 includes the gas barrier layer 702 that is provided inward of the first adhesive layer 704 and the second adhesive layer 706, and the moisture barrier layer 705 that is provided outward of the gas barrier layer 702 (FIG. 10). With this configuration, even when the liquid containing portion 32 contains a liquid that contains an organic solvent as the main solvent, the gas barrier layer 702 is located inward of the first adhesive layer 704 and the second adhesive layer 706 and it is therefore possible to prevent the organic solvent from moving to the outside of the gas barrier layer 702 even if the organic solvent evaporates. Accordingly, the possibility of the evaporated organic solvent reaching the first adhesive layer 704 and the second adhesive layer 706 can be reduced, and a reduction (deterioration) in the functions of the first adhesive layer 704 and the second adhesive layer 706 can be suppressed. Here, the liquid that contains an organic solvent as the main solvent may produce an unintended substance when mixed with moisture that has entered from the outside. According to the first embodiment, because the liquid containing portion 32 includes the moisture barrier layer 705, it is possible to prevent moisture from entering from the outside, and the production of an unintended substance can be suppressed. Also, in the case where a material that has high affinity for water (for example, an ethylene vinyl alcohol copolymer) is used to form the gas barrier layer 702, the gas barrier layer 702 may absorb moisture when the surrounding region of the gas barrier layer 702 has high levels of moisture , and the gas barrier performance may be reduced. According to the first embodiment, because the moisture barrier layer 705 is provided outward of the gas barrier layer 702, it is therefore possible to prevent moisture entering from the outside from reaching the gas barrier layer 702. Accordingly, it is possible to prevent a reduction in the gas barrier performance of the gas barrier layer 702.

Also, according to the first embodiment described above, gas barrier properties can be imparted to the outer bag 330 by the gas barrier layer 702, and moisture barrier properties can be imparted to the outer bag 330 by the moisture barrier layer 705 while the inner bag 320 is formed using a monolayer including the inner heat seal layer 601. Also, according to the first embodiment described above, the layer structure 800 includes the heat seal layers 601 and 701 located inward of the gas barrier layer 702. With this configuration, adjacent layers can be thermally fuse-bonded to each other using the heat seal layers 601 and 701.

Also, according to the first embodiment described above, no adhesive layer is disposed between the inner heat seal layer 601, which is the innermost layer that is in contact with the containing space 399, and the gas barrier layer 702 (FIG. 10). With this configuration, it is possible to, even when the liquid containing portion 32 contains a liquid that contains an organic solvent as the main solvent, suppress a reduction in the function of the adhesive layer caused by evaporated organic solvent. Also, according to the first embodiment described above, in the case of a configuration in which a plurality of layers are integrally stacked between the inner heat seal layer 601 and a layer including the gas barrier layer 702, a co-extruded layer 708 is formed by the plurality of layers being integrally stacked through co-extrusion. In the co-extruded layer 708, the plurality of layers can be integrally stacked without forming an adhesive layer, and it is therefore possible to suppress a reduction in the function of the adhesive layer caused by evaporated organic solvent.

Also, according to the first embodiment described above, the liquid containing portion 32 is formed by fuse-bonding the first film member 340 and the second film member 350. With this configuration, the liquid containing portion 32 can be easily formed using two film members 340 and 350. Also, according to the first embodiment described above, the liquid containing portion 32 includes the surface protection layer 707 at the outermost position, and it is therefore possible to reduce the possibility of the liquid containing portion 32 being damaged by an external force applied as a result of the liquid containing portion 32 coming into contact with another member or the like.

### B. Second Embodiment

FIG. 11 is a diagram illustrating a layer structure 800a of a liquid container 30a according to a second embodiment. The liquid container 30a according to the second embodiment and the liquid container 30 according to the first embodiment are different in that they have different layer structures 800 and 800a. As in the first embodiment, a liquid containing portion 32a is a double bag formed by an inner bag 320a and an outer bag 330a. Also, as in the first embodiment, the liquid containing portion 32a is a pillow-type bag-like body formed by thermally fuse-bonding outer peripheral portions of a first film member 340a and a second film member 350a. The first film member 340a and the second film member 350a have the same layer structure 800a.

The layer structure 800a includes, in order from the inside toward the outside, a first inner heat seal layer 611 that serves as a heat seal layer, a gas barrier layer 612, a second inner heat seal layer 613 that serves as a heat seal layer, an outer heat seal layer 711, a first adhesive layer 712 that serves as an adhesive layer, a moisture barrier layer 713, a second adhesive layer 714 that serves as an adhesive layer, and a surface protection layer 715.

The inner bag 320a constitutes a co-extruded layer (multilayer film layer) 615 in which the first inner heat seal layer 611, the gas barrier layer 612, and the second inner heat seal layer 613 are stacked in this order from the inside toward the outside. The co-extruded layer 615 is integrally formed without using an adhesive by co-extruding adjacent layers.

The first inner heat seal layer 611, the second inner heat seal layer 613, and the outer heat seal layer 711 are each made of a synthetic resin that is heat sealable with an adjacent member (layer). As the heat sealable synthetic resin, it is possible to use, for example, polyethylene or polypropylene, as with the heat seal layers 601 and 701 of the first embodiment. The gas barrier layer 612 is a layer (film layer) for preventing the passage of gas. As with the gas barrier layer 702 of the first embodiment, the gas barrier layer 612 is formed by, for example, a synthetic resin layer such as a film layer made of ethylene vinyl alcohol copolymer (EVOH), or a film layer containing EVOH.

The first adhesive layer 712 is a layer that is provided between the outer heat seal layer 711 and the moisture barrier layer 713 so as to bond the outer heat seal layer 711 and the moisture barrier layer 713 to each other. As with the adhesive layers 704 and 706 of the first embodiment, the first adhesive layer 712 is a layer made of various types of adhesives, and is, for example, a layer made of an adhesive obtained by dissolving an adhesive resin in a solvent, such as an amino resin-based adhesive, a phenol resin-based adhesive, an epoxy-based adhesive, a polyurethane-based adhesive, or the like.

The moisture barrier layer 713 is a layer (film layer) for preventing the passage of moisture. The moisture barrier layer 713 prevents, for example, moisture from entering into the containing space 399 from the outside of the liquid containing portion 32, or moisture from moving from the inside toward the outside. The moisture barrier layer 713 is, for example, at least either a deposition film or a metal foil, as with the moisture barrier layer 705 of the first embodiment.

The second adhesive layer 714 is the same layer as the second adhesive layer 706 of the first embodiment (FIG. 10), and is a layer provided between the moisture barrier layer 713 and the surface protection layer 715 so as to bond the moisture barrier layer 713 and the surface protection layer 715 to each other. As the material of the second adhesive layer 714, the same material as that used in the second adhesive layer 706 can be used.

The surface protection layer 715 is the same layer as the surface protection layer 707 of the first embodiment, and is the outermost layer (film layer). The surface protection layer 715 is a layer for protecting the liquid containing portion 32 from an external force (impact) applied from the outside. As the material of the surface protection layer 715, the same material as that used in the surface protection layer 707 of the first embodiment can be used.

According to the second embodiment described above, the same advantageous effects as those of the first embodiment are obtained because the second embodiment has a similar configuration to that of the first embodiment. For example, according to the second embodiment described above, the layer structure 800a of the liquid containing portion 32a includes the gas barrier layer 612 that is provided inward of the first adhesive layer 712 and the second adhesive layer 714, and the moisture barrier layer 713 that is provided outward of the gas barrier layer 612 (FIG. 11). With this configuration, even when the liquid containing portion 32 contains a liquid that contains an organic solvent as the main solvent, the gas barrier layer 612 is inward of the first adhesive layer 712 and the second adhesive layer 714, and it is therefore possible to prevent the organic solvent from moving to the outside of the gas barrier layer 612 even if the organic solvent evaporates. Accordingly, the possibility of an evaporated organic solvent reaching the first adhesive layer 712 and the second adhesive layer 714 can be reduced, and it is therefore possible to suppress a reduction (deterioration) of the functions of the first adhesive layer 712 and the second adhesive layer 714.

Also, according to the second embodiment described above, in the inner bag 320a, the first inner heat seal layer 611, the gas barrier layer 612, and the second inner heat seal layer 613 are stacked in this order from the inside toward the outside. Also, the outer bag 330a includes, in order from the inside toward the outside, the outer heat seal layer 711 and the moisture barrier layer 713 (FIG. 11). With this configuration, the inner bag 320a can have gas barrier properties, and the outer bag 330a can have moisture barrier properties.

### C. Additional Embodiments

The present invention is not limited to the embodiments and examples given above, and can be carried out in various forms without departing from the gist thereof. For example, the following variations are possible.

### C-1. First Additional Embodiment

In the embodiments given above, the liquid contained in the liquid containing portions 32 and 32a is not limited to a liquid in which an organic solvent is used as the main solvent (for example, a solvent ink) as long as the liquid can be supplied to the liquid consumption apparatus 10. The liquid may be a liquid in which water is used as the main solvent (for example, a water-based ink), or the like.

### C-2. Second Additional Embodiment

In the embodiments given above, the liquid containing portions 32 and 32a are each a pillow-type bag-like body formed by bonding two film members together, but the liquid containing portions 32 and 32a are not limited thereto. The liquid containing portions 32 and 32a may be each a pouch-type bag-like body formed by bonding three or more film members together.

### C-3. Third Additional Embodiment

In the embodiments given above, the layer structures 800 and 800a may include an intermediate protection layer that sandwiches at least one of the gas barrier layer 612 or 702 and the moisture barrier layer 705 or 713. As the material of the intermediate protection layer, the same material as that used in the surface protection layers 707 and 715 can be used. For example, the intermediate protection layer may be made of nylon. With this configuration, the gas barrier layer 612 or 702, and the moisture barrier layer 705 or 713 can be protected by the intermediate protection layer.

### C-4. Fourth Additional Embodiment

The application of the present invention is not limited to an inkjet-type textile printing machine, and a liquid container for supplying ink to an inkjet-type textile printing machine. The present invention is also applicable to any liquid consumption apparatus that ejects a liquid other than ink, and a liquid container for housing such a liquid. The present invention is applicable to, for example, the following various types of liquid consumption apparatuses and liquid containers: (1) an image recording apparatus such as a facsimile apparatus; (2) a colorant injection apparatus used to produce a color filter for an image display apparatus such as a liquid crystal display; (3) an electrode material injection apparatus used to form electrodes for an organic EL (electro luminescent) display, a surface emission display (field emission display, FED), or the like; (4) a liquid injection apparatus that injects a liquid containing a biological organism for use in biochip fabrication; (5) a sample injection apparatus as a precision pipette; (6) a lubricating oil injection apparatus; (7) a resin solution injection apparatus; (8) a liquid injection apparatus that injects lubricating oil to a precision machine such as a timepiece or a camera with pinpoint accuracy; (9) a liquid injection apparatus that injects a transparent resin solution such as an ultraviolet curable resin solution onto a substrate so as to form a micro hemispherical lens (optical lens) used in an optical communication element, or the like; (10) a liquid injection apparatus that injects an acid or alkaline etching solution so as to etch a substrate or the like; and (11) a liquid injection apparatus that includes a liquid injection head that ejects a micro amount of droplets of any liquid.

As used herein, the term “droplets” refers to a state of a liquid ejected by a liquid injection apparatus, and encompasses granule-like droplets, tear drop-like droplets, and filament-like elongated droplets. Also, the term “liquid” as used herein may be any material that can be ejected by a liquid injection apparatus. For example, the term “liquid” may be a material in which the substance is in a liquid phase. Materials in a liquid state that have high or low viscosity, and materials in a liquid state such as sol, gel water, other inorganic solvents, organic solvents, solutions, liquid resins, liquid metals (metal melts) are also encompassed in the term “liquid”. Also, the term “liquid” also encompasses, not only liquids as one state of a substance, but also liquids obtained by dissolving, dispersing or mixing particles of a functional material made of a solid substance such as a pigment or metal particles in a solvent. Typical examples of the liquid include ink described in the embodiments given above, liquid crystal, and the like. As used herein, the term “ink” encompasses ordinary water-based ink and oil-based ink, as well as various types of liquid compositions such as gel ink, and hot melt ink.

The present invention is not limited to the embodiments, examples, and variations given above, and may be implemented in various types of configurations within the scope that does not depart from the gist thereof. For example, the embodiments that correspond to the technical features according to the aspects described in the summary section, examples and the technical features in the variations may be replaced or combined as appropriate in order to solve a portion or all of the problems described above, or to achieve a portion or all of the advantageous effects described above. Also, technical features that are described as not being essential in this specification may be omitted as appropriate.

The present application is based on, and clams priority from JP Application Serial Number 2017-212648, filed Nov. 2, 2017.

What is claimed is:

1. A liquid container for supplying a liquid to a liquid consumption apparatus, the liquid container comprising:
a liquid containing portion in which a containing space for containing the liquid is formed, the liquid containing portion including a flexible inner bag that comes into contact with the containing space on inside of the inner bag, and a flexible outer bag that is located outside of the inner bag;
a connection portion that is detachable from the liquid consumption apparatus, and allows the liquid contained in the liquid containing portion to flow into the liquid consumption apparatus; and
a housing box that houses the liquid containing portion,
wherein the liquid containing portion forms a layer structure in which a plurality of layers are disposed from the inside toward the outside, and
the layer structure includes an adhesive layer, a gas barrier layer that is provided inward of the adhesive layer, and a moisture barrier layer that is provided outward of the gas barrier layer.

2. The liquid container according to claim 1,
wherein the moisture barrier layer is at least either a deposition film or a metal foil.

3. The liquid container according to claim 2,
wherein the deposition film is formed by any one of a silica deposition film layer obtained by depositing silica on a base substrate, an alumina deposition film layer obtained by depositing aluminum oxide on a base substrate, and an aluminum deposition film layer obtained by depositing aluminum on a base substrate.

4. The liquid container according to claim 2,
wherein the metal foil is an aluminum foil.

5. The liquid container according to claim 1,
wherein the gas barrier layer is made of a synthetic resin that contains an ethylene vinyl alcohol copolymer.

6. The liquid container according to claim 1,
wherein, in the layer structure, the adhesive layer is not provided between the inner most layer that is in contact with the containing space and the gas barrier layer.

7. The liquid container according to claim 6,
wherein the layer structure includes, between the innermost layer and a layer including the gas barrier layer, a co-extruded layer in which a plurality of layers are stacked through co-extrusion.

8. The liquid container according to claim 1,
wherein the layer structure includes a heat seal layer that is provided inward of the gas barrier layer.

9. The liquid container according to claim 8,
wherein the inner bag is formed using a monolayer that is an inner heat seal layer serving as the heat seal layer, and
the outer bag includes, in order from the inside toward the outside, an outer heat seal layer that serves as the heat seal layer, the gas barrier layer, and the moisture barrier layer.

10. The liquid container according to claim 9,
wherein the inner heat seal layer is thicker than the outer heat seal layer.

11. The liquid container according to claim 8,
wherein the inner bag includes, in order from the inside toward the outside, a first inner heat seal layer that serves as the heat seal layer, the gas barrier layer, and a second inner heat seal layer that serves as the heat seal layer, and
the outer bag includes, in order from the inside toward the outside, an outer heat seal layer that serves as the heat seal layer, and the moisture barrier layer.

12. The liquid container according to claim 1,
wherein the liquid containing portion includes:
a first film member that is formed by a first inner film that constitutes the inner bag, and a first outer film that constitutes the outer bag; and
a second film member that is formed by a second inner film that constitutes the inner bag, and a second outer film that constitutes the outer bag,
wherein an outer peripheral portion of the first film member and an outer peripheral portion of the second film member are fuse-bonded together.

13. The liquid container according to claim 1,
wherein the layer structure includes a surface protection layer as the outermost layer.

14. The liquid container according to claim 1,
wherein the layer structure includes an intermediate protection layer that sandwiches at least one of the gas barrier layer and the moisture barrier layer.
